(19) United States
(12) Patent Application Publication
(10) Pub. No.: US 2008/0304005 A1
(43) Pub. Date: Dec. 11, 2008

(54) Eyewear Frames With Mechanical Lock Lens Attachments

(76) Inventor: Carmine S. DiChiara, Warren, NJ (US)

Correspondence Address: John r Lane;Frommer Lawrence & Haug LLP, 745 Fifth Avenue, New York, NY, 10151, US

(21) Appl. No.: 11/658,389

(22) PCT Filed: Jan. 11, 2007
(86) PCT No.: PCT/US07/00685

§ 371 Date: Jan. 25, 2007

Related U.S. Application Data
(60) Provisional application No. 60/758,565, filed on Jan. 13, 2006.

(51) Int. Cl. G02C 1/04

(52) U.S. Cl. 351/106; 351/103

(57) ABSTRACT

The present invention relates to partial rim eyewear or eyeglasses having impact resistant prescription lenses and mechanically secured to the frame. The eyeglasses are particularly useful for athletic activity because they are lightweight and offer a wide field of vision because they do not comprise of a full rim. The lenses are to be prescription either tinted, or clear, with or without coatings that may be preferred for use with athletic activities. The mechanical lock attachment to secure each lens in place can include adhesives or double sided adhesive tape, notches in the partial rim frame with corresponding protrusions in the lens, with or without a lock clip engaging the lens and a locking pin engaging the lock clip; and/or a screw, adhesive or double-sided tape. Advantageously, the lenses are impact resistant and are securely attached to the frame via these different mechanical attachments. The mechanical attachments can be constructed so that it is difficult to remove it from the frame, making or is a permanent attachment, thereby securely locking the lens in place even under severe impact. In additional embodiments, the mechanical lock attachment can include a double bar support or a single bar support. The double bar support pivots over the lenses and is locked to the frame with a pin or screw or other method. The single bar support is positioned over the lenses and is locked to the frame with a bar clip, pin or screw engaging the nose piece, and double sided adhesive tape can be added for additional strength.

This application is based upon provisional patent application Ser. No. 60/758,565, which was filed on Jan. 13, 2006.

### FIELD OF THE INVENTION

The present invention relates to eyewear frames having mechanical lock lens attachments. More specifically, the invention relates to eyewear frames having impact resistant lenses attached to partial rim frames with a mechanical lock at the top and or side arcuate surface of the frame. Prescription lenses of various different powers and colors can be fitted to the frames.

### BACKGROUND OF THE INVENTION

Many people of all ages are engaging in sports activities without protecting their eyes with the proper eyewear. They often wear sunglasses or street wear frames that do not offer adequate impact protection.

Conventional mountings can create problems upon impact, when the wearer is struck by a flying object and the eyeglasses are knocked off the wearer's face. Conventional eyewear frames are sometimes too bulky or too heavy for sports activities that athletes choose not to wear them and thus forego eye protection.

Examples of prior eyewear frames are disclosed in the following U.S. patents, the disclosures of which are hereby incorporated herein by reference: U.S. Pat. No. 3,229,303 to Jonassen, U.S. Pat. No. 3,869,200 to Danylewich, U.S. Pat. No. 4,730,915 to Jannard, U.S. Pat. No. 5,467,148 to Conway, U.S. Pat. No. 5,587,747 to Bernheiser, U.S. Pat. No. 5,971,536 to Chiu, U.S. Pat. No. 6,210,001 to Huang, U.S. Pat. No. 6,224,209 to Chen, U.S. Pat. No. 6,742,890 to Teng, and U.S. Pat. No. 6,863,395 to Teng.

Accordingly, there is a need for providing protective eyewear for athletes that protect the wearer from eye injuries occurring during sports activities. There is a need for providing lightweight eyewear that is fashionable and comfortable to wear during sports activities.

### SUMMARY OF THE INVENTION

An object of the present invention is to provide impact resistant Rx'able eyeglasses having lenses attached to a frame with a mechanical lock.

Another object of the present invention is to provide eyeglasses having a blade-style impact resistant lens.

Another object of the present invention is to provide Rx'able Eyeglasses with partial frame rims that will be impact resistant.

This is attainable by the sole or combined use of adhesives, double-sided adhesive tape, notches, screws, pins, or any other form of mechanical attachment, which will cause the frame and lens combination to withstand impact.

A further object of the invention is to provide Rx'able eyeglasses having a mechanism to prevent the lenses from moving out of their engagement with the frame.

Still another object of the invention is to provide eyeglasses having a bar support that can be removed to attach the lenses and then replaced and then secured with a clip.

Yet another object of the invention is to provide eyeglasses having a double bar support that can be removed to attach the lenses, replaced, and then secured with a screw, a pin, or double sided adhesive tape.

These objects are basically attained by providing eyewear or eyeglasses having a frame with a horizontal bar, a nosepiece, and a pair of impact resistant lenses. The impact resistant lenses are locked into a frame via a locking mechanism located on the horizontal bar, or nasal bridge, or endpieces of the frame. The locking mechanism can include a slideable bar or lock clip engaged and secured by a locking pin, or a single or double bar support for use with pins, screws, bridge clip, or double-sided adhesive tape.

Other objects, advantages, and salient features of the present invention will become apparent from the following detailed description, which, taken in conjunction with the annexed drawings, discloses preferred embodiments of the invention.

### BRIEF DESCRIPTION OF THE DRAWINGS

FIG. 1 is a front, perspective view of eyewear according to a first embodiment of the invention;

FIG. 2 is a front view in partial section of the eyewear illustrated in FIG. 1 with the lenses removed;

FIG. 3 is a front view in partial section of the eyewear with the left lens secured to the frame with a sliding lock clip and locking pin according to the first embodiment illustrated in FIGS. 1-2;

FIG. 4 is a front view in partial section of the eyewear showing the left side with the mechanical lock clip, lens, and locking pin removed from the frame according to the embodiments illustrated in FIGS. 1-3;

FIG. 5 is a top view of the lock clip;

FIG. 6 is a left side view of the lock clip;

FIG. 7 is a rear view of a second embodiment of the invention showing a double bar support in a closed position, with the levers pinned into the frame;

FIG. 8 is a rear view of the second embodiment of FIG. 7 showing the double bar support in an open position, with the levers unpinned from the frame;

FIG. 9 is a rear view of a third embodiment of the invention showing a single bar support with the lenses removed from the frame; and

FIG. 10 is a rear view of a fourth embodiment of the invention showing the single bar support with the lenses removed from the frame and double-sided adhesive tape between the lenses and the frame.

FIG. 11 is a rear view of a single locking bar and lock clip, as were shown in FIGS. 9 and 10, according to one embodiment of the present invention;

FIG. 12 is a rear view of a frame, two lenses, and double-sided tape or adhesive, as were shown in FIG. 10, according to one embodiment of the present invention;

FIG. 13A is a front view of yet another embodiment of the invention showing a lens having two protrusions secured to a recess in a frame with double sided tape or other adhesive;

FIG. 13B is a front view of a frame and lens having two protrusions that is insertable into a recess in a frame and secured with double-sided tape or adhesive;

FIG. 13C is a cross-sectional view of the embodiment shown in FIGS. 13A and 13B, showing a lens with two protrusions and double-sided tape or adhesive capable of being inserted to a recess in a frame having double sided tape or adhesive;

FIG. 14A is a rear view of yet another embodiment of the present invention showing a frame and two lenses without protrusions insertable into a recess in the frame and a double bar support in the open position;

FIG. 14B is a rear view of another embodiment of the invention showing a single bar support and two lenses without protrusions that may be secured to a recess in the frame with the assistance of double sided tape or adhesive;

FIG. 14C is a front view of another embodiment of the invention showing a frame with a recess, a detached lens, and holes for receipt of a screw or pin;

FIG. 14D is a front view of another embodiment of the invention showing a frame with a recess, a secured lens, and screws or pins securing the lens to the frame;

FIG. 14E is a cross-sectional view of the embodiment shown in FIGS. 14C and 14D, showing a lens secured to a frame with a screw or pin.

### DETAILED DESCRIPTION OF THE INVENTION

The eyewear or eyeglasses of the present invention are particularly useful for athletic activity because they are lightweight and the prescription lenses are inserted and can be impact resistant in accordance with the F803 ASTM standard and other similar standards, with respect to protective or sport glasses. With respect to sport glasses, many athletes choose less bulky frames that maximize their field of vision with the least amount of frame support around lenses.

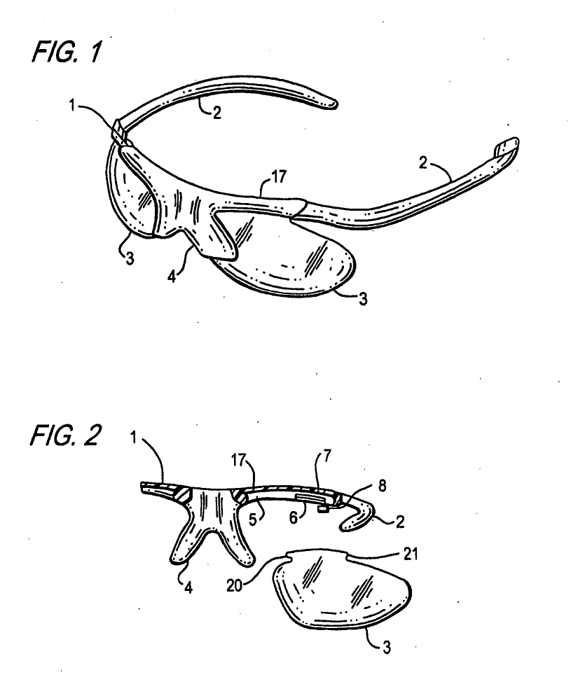

Referring to FIGS. 1 and 2, a pair of eyeglass frames with a mechanical lock lens attachment includes a frame 1, a nosepiece 4, and two lenses 3. The frame includes a horizontal arm 17 positioned between first and second temple pieces 2, temple pieces 2 extending behind the frame 1, and a channel 5 formed in the horizontal arm 17 and around the outer edges of the nosepiece 4. The mechanical lock lens attachment includes a slideable lock clip 7, a locking pin 8, and two slots 6 for accommodating the slideable lock clip in the channel 5.

The frame 1 is a conventional winged frame designed so that there are no rims surrounding the lower arcuate surfaces of the lenses 3. In other words, the lenses 3 look like wings hanging down from the horizontal arm 17. Only the upper sections of the lenses 3 are engaged by the frame 1. The points of contact between the frame 1 and the lenses 3 comprise a first section of a channel 5 located in the horizontal arm 17 of the frame 1 and a second section of the channel 5 located in the side wall adjacent to the nosepiece 4.

The nosepiece 4 is located at the center of the horizontal arm 17. It protrudes below the horizontal arm 17 of the frame 1 to support the eyeglasses on the user's nose. The nosepiece 4 is further defined by two channels 5 for receiving the lenses 3, one on each side of the nosepiece 4. Both the channel 5 of the horizontal arm 17 of the frame and the channels 5 surrounding the nosepiece 4 are of a suitable size to slidably receive and tightly wrap around the sides of the lenses 3.

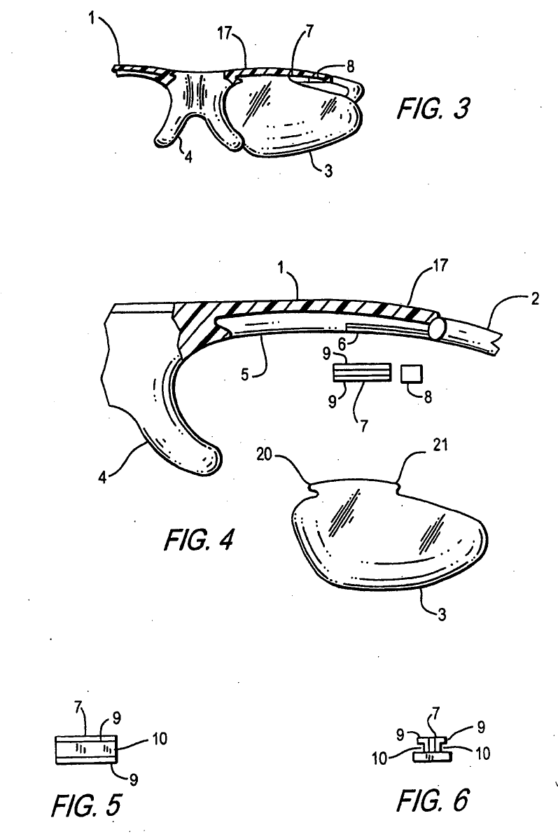

As seen in FIGS. 3 through 6, the frame 1 further includes the mechanical lock lens attachment. The lock clip 7 is a slidable bar, captured in two inwardly facing slots 6 of the channel 5 of the horizontal arm 17 of the frame 1. The lock clip 7 has an I-shaped cross section as seen in FIG. 6 including two outwardly facing rails 9. The rails 9 arc slidably received in two inwardly facing slots 6 in the channel 5 of the frame 1 to prevent the lock clip 7 from moving vertically relative to the frame 1. The inwardly facing slots 6 in the channel 5 supports the lock clip 7 and allows the lock clip 7 to move along the channel 5, once the lens 3 is positioned in the channel 5. Once the lock clip 7 is slid into place over the lens 3, thereby securing the lens 3 to the frame 1, a locking pin 8 is secured in the inwardly facing slots 6 between the lock clip 7 and the temple or endpieces. The locking pin 8 thereby prevents the lock clip 7 from sliding away from the lens and releasing it. This process will be described in further detail below.

The lenses 3 are located adjacent opposite sides of the nosepiece 4 and below the horizontal arm 17 of the frame 1. The lenses 3 are blade-style lenses defined by a first protrusion or tab 20 and a second protrusion or tab 21 on the upper portion of the lens 3, closest to the horizontal arm 17 of the frame 1, as seen in FIG. 2.

The lens 3 is positioned in the frame channel 5 and includes first outwardly protruding tab 20 and second outwardly protruding tab 21, the tabs facing opposite directions. The first tab 20 is directed towards the interior section of the frame 1, specifically, towards the nosepiece 4. The second tab 21 is directed towards the outer portion of the frame, specifically, towards the temple pieces 2 and end pieces.

The lenses 3 are secured to the frame via a sliding lock clip 7 and a locking pin 8 received by the slot 6 in the channel 5 that passes along the horizontal arm 17. The lenses 3 are placed into the channel 5 that passes through the horizontal arm 17. The first protruding tab 20 of the lens 3 slides into a portion of the channel 5 shaped to receive it, at the top of the frame 1 towards the nosepiece 4. The second protruding tab 21 is secured to the frame by sliding the lock clip 7 along the channel 5 of the frame 1 and over the second protrusion 21 of the lens 3 to allow room in the channel 5 for receiving the locking pin 8. The lock clip 7 is prevented from dislodging by the insertion of the locking pin 8, thereby restricting movement in the assembly, also illustrated in FIG. 2.

As illustrated in FIGS. 2 through 6, to lock the lens 3 to the frame 1, the protrusions of each lens 3 is placed into the channel 5 of the horizontal arm 17. The first protruding tab 20 is received in a first recess in the channel 5. Then, the lock clip 7 is slid from the outer edge of the horizontal arm 17, closest to the temple pieces 2, towards the nose piece 4 until the recess 10 in the lock clip 7 engages the second tab 21. Finally, the locking pin 8 is placed into the channel 5 between an end of the lock clip 7 and the outer end of the channel 5. The locking pin 8 engages the lock clip 7, and securely locks the lens 3 to the frame, thus preventing the lens 3 from being dislodged and preventing the lock clip 7 from moving out of engagement with the second tab on the lens 3, as seen in FIG. 3. The lens 3 is secured between the upper section of the frame 1, the nosepiece 4, and the lock clip 7. To aid in rigidly supporting the lock clip 7 in place, it can have a wedge-shaped configuration or can have serrated sides for engagement with corresponding serrated sides of the lock clip 7 and the end of the channel 5. The lock clip may be shaped to fit into the slots 6 to ensure its stability, but those skilled in the art will appreciate that there are other ways to secure the locking pin 8 in place so that it prevents lock clip 7 from sliding back toward temple or end piece 2.

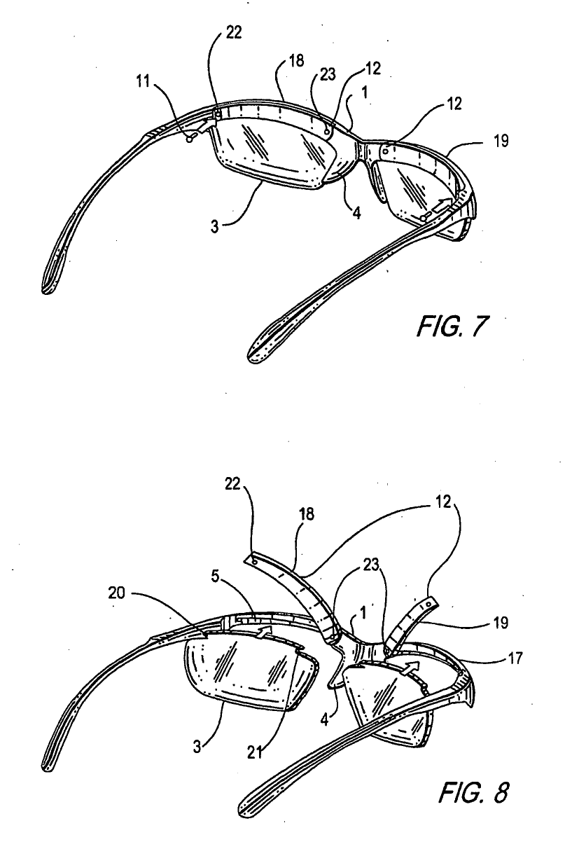

FIGS. 7-10 illustrate additional embodiments of the invention wherein the mechanical lock lens attachment can be selected from the group comprising a screw, a pin, or a bar clip, as well as a single bar support or a double bar support. The frame 1 is a winged frame, similar to the frame in the above described embodiments. The lenses 3 are also similar to those in the above described embodiments. They are blade style lenses 3 defined by a first protrusion 20 and a second protrusion 21 on the upper portion of the lens 3, closest to the horizontal arm 17 of the frame 1. Only the upper sections of the lenses 3 are engaged by the frame 1. Further, the protrusion includes first outwardly protruding tab 20 and second outwardly protruding tab 21 facing opposite directions. A channel or recess 5 in the horizontal arm 17 of the frame 1 is shaped to receive the first protrusion 20 and the second protrusion 21 of the lens 3. The embodiments illustrated show a lens with two protruding tabs. Those skilled in the art will recognize that protrusions of different numbers or shapes may also be used.

As seen in FIGS. 7 and 8, eyeglasses with a mechanical lock lens attachment includes a frame 1, a nosepiece 4, two lenses 3, and two pivotable bars or levers 18 and 19. First and second levers 18 and 19 form a double bar support 12 that traps the lenses 3 between the levers 18 and 19 and the frame 1. The levers are located on opposite sides of the nosepiece 4, behind the frame 1. The levers 18 and 19 are pivotally attached to the frame 1, near the nosepiece 4, with a screw or pin 23. The levers or bars may also be affixed in different manners recognizable to a person having ordinary skill in the art, such as a sliding bar or a clip-over bar instead of a pivoting bar. A lever could be a bar or any other suitable means for securing the lenses to the frames. A single bar or lever spanning both lenses could also be used instead of multiple levers.

FIG. 7 depicts the double bar support 12 in a closed position. The first 18 and second 19 levers are locked to the outer edges of the frame 1, furthest from the nosepiece 4, with an additional screw or pin 11.

FIG. 8 illustrates the structure of the double bar support 12 in an open position. A channel 5 is located in the horizontal arm 17 of the frame to receive the lenses 3. The channel 5 is shaped to receive the protrusion on the upper portion of the lens 3. The first and second protruding tabs 20 and 21 of the lenses 3 are received into the channel 5. Once the lenses 3 are placed in the frame 1, the levers 18 and 19 close over the lenses 3, creating a wall and layering the lenses 3 between the levers 18 and 19 and the frame 1.

Finally, a retaining mechanism 11 such as a screw or pin engages each lever 18 and 19 and frame 1 to mechanically lock the lenses 3 to the frame 1. The outer edge of each lever 18 and 19 comprises an opening 22 for receiving the retaining mechanism 11. The inner screw or pin 23 is tightly attached to the frame 1, enough such that it cannot slip out of the frame 1, but the inner pin 23 is attached loosely enough to allow the levers 18 and 19 to pivot. This pivoting motion of the levers opens like a drawbridge, each lever pivoting upwardly, away from the lens 3. This allows enough space for the frame to receive the lens 3.

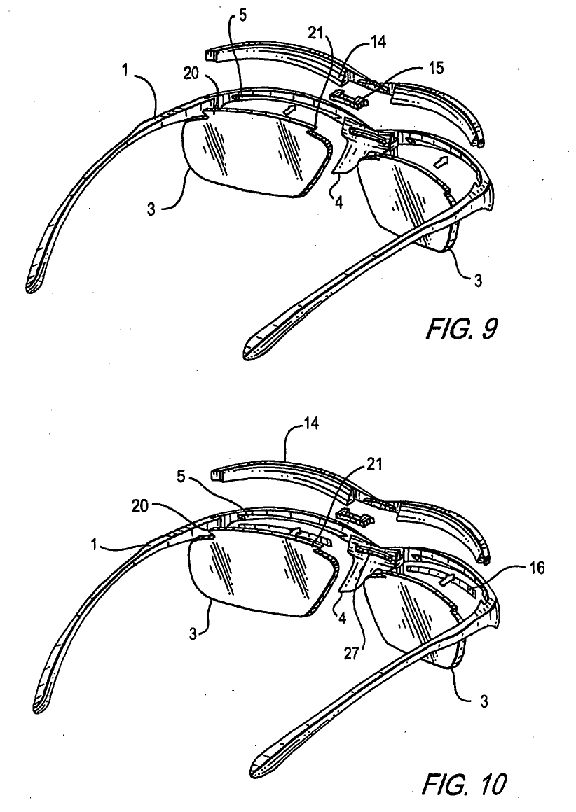

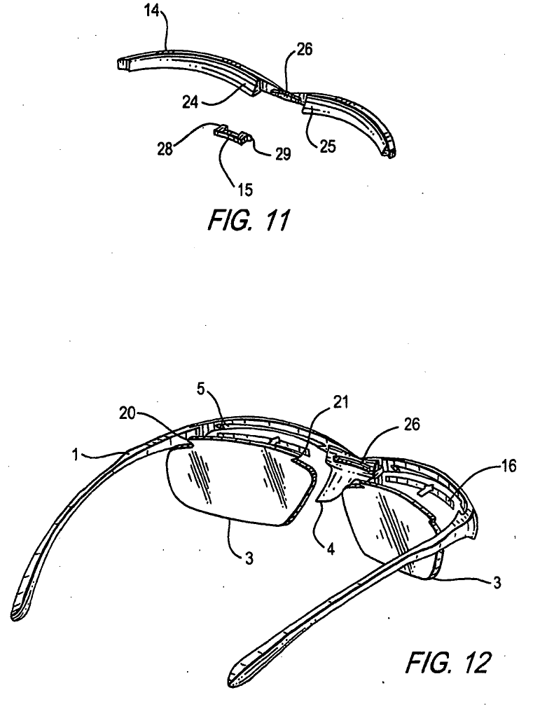

Turning to FIGS. 9 through 12, eyeglasses with a mechanical lock lens attachment include a frame 1, a nosepiece 4, two lenses 3, a single bar support 14, and a bar clip 15. A single bar support 14 is a lengthwise bar comprising curved sections that follow the substantially arched sections of the frame. The single bar support 14 comprises first and second protrusions 24 and 25 attached to the inner wall of the bar, each protrusion adjacent to the nosepiece 4 and endpiece. The single bar is shaped to replicate the curvature of the lens, creating the channel that secures the frame and lenses together. Additionally, the single bar support comprises of protrusions at the bar ends, and a recess in the nasal area, that allows the bar to slide down and nest into the frame endpieces and a slot in the center of the bar for receiving the bar clip.

The nosepiece 4, located in the middle of the frame 1, comprises a substantially rectangular shaped recess 27 for receiving a bar clip 15. The nosepiece 4 is further defined by an inlet on the upper surface of the nosepiece 4, perpendicular to the bar clip 15 for receiving the single bar support 14.

Once the lenses 3 are placed into the frame 1, as described in the above embodiments, the single bar support 14 is slidably received in the frame 1 and over the lenses 3 thereby securing the lenses to the frame. A bar clip 15, comprising first and second legs 28 and 29 on each end of the bar clip 15, engages the recess 27 in the nose piece 4. The legs 28 and 29 pass through the recess 27 and hook into the slot 26 of the single bar support 14. The legs 28 and 29 aid to securely lock the bar clip 15 into the single bar support 14.

When the single bar support 14 is in a closed position (not shown), overhang the bar support completes the channel for the lens and the securing of the lens to the frame.

FIG. 10 illustrates the single bar support 14 as described above with an additional securing or locking mechanism. This embodiment includes the use of double sided adhesive tape 16 to further secure the lenses 3 to the frames 1, strengthening the connection between the lenses and the front inner wall of the lens channel. Other adhesives may be used in addition to double sided adhesive tape. Double sided adhesive tape 16 is used to attach the lenses 3 to the inner wall of the frame channel. One side of the tape 16 attaches to the frames 1, against the channel 5 wall. The opposite side of the tape 16 attaches to the lens 3. The tape 16 helps to maintain the lenses 3 in place before the single bar support 14 is placed over the lenses 3 and frames 1 and further secures the lens and frame together. The adhesive or double sided tape 16 can be applied to any surface of channel 5. FIGS. 9 through 12 show an embodiment of the invention using lenses 3 having a first notch 20 and second notch 21. The locking bar or lever, in combination with adhesive or double sided tape, provides sufficient support for a lens with no protrusions to adequately withstand impact.

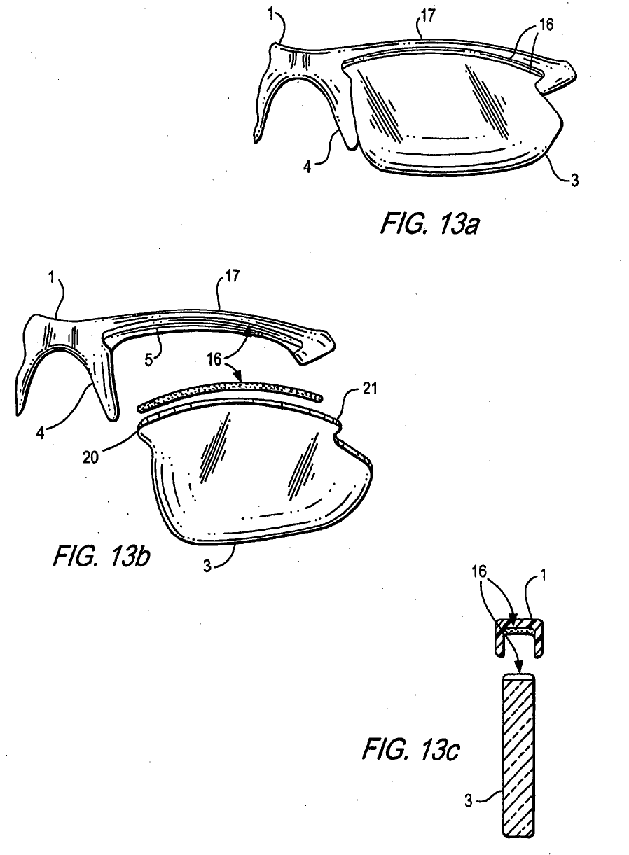

FIG. 13A shows a pair of eyeglass frames 1 having a horizontal arm 17 and a nose piece 4. A lens 3 is secured to the frame 1 using double sided tape or other adhesive. The frame 1 is of a conventional winged design.

FIG. 13B shows the eyeglass assembly of FIG. 13A disassembled. There is a channel 5 in the horizontal arm 17 of the frame 1. Double sided tape or adhesive 16 is secured to the inside of the channel 5. The lens 3 has a first protrusion 20 and a second protrusion 21. Double sided tape or adhesive 16 is secured to the lens 3. The channel 5 is shaped to receive the first protrusion 20 of the lens 3 near the nosepiece 4 of the frame 1. The channel 5 is also shaped to receive the second protrusion 21 of the lens 3 near the temple or end piece of the frame 1. The combination of double sided tape or adhesive with the protrusions on the lens received in the recess of the horizontal arm will prevent the lens from ejecting out of the frame or breaking under impact.

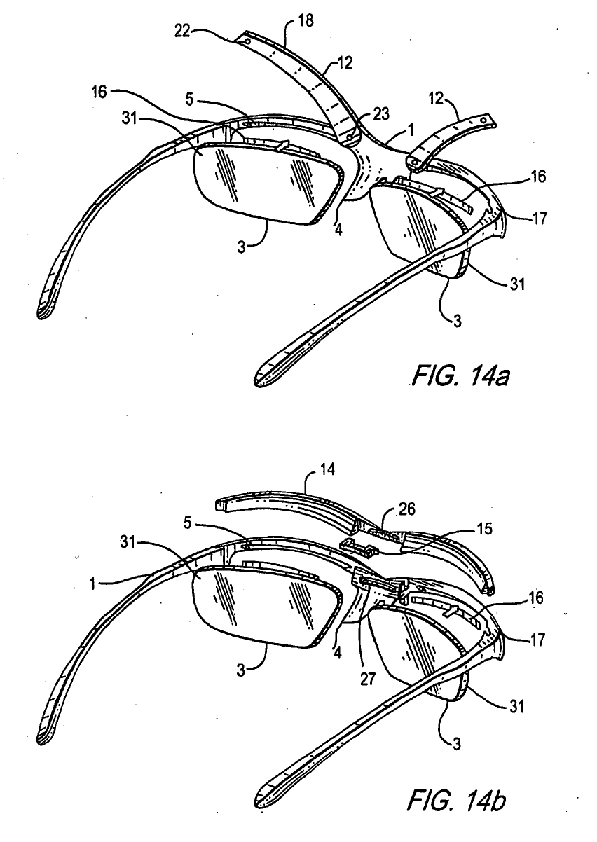

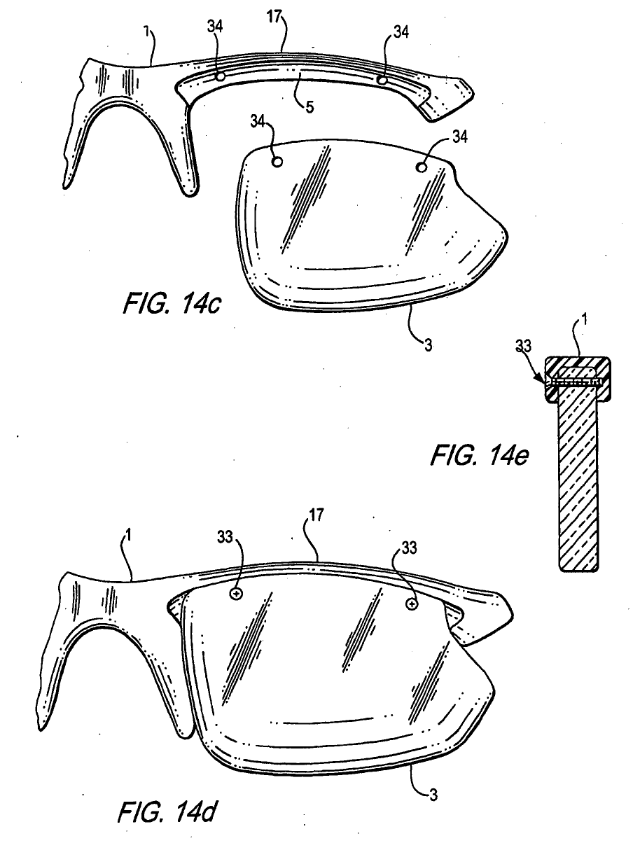

FIG. 14A shows another embodiment of the present invention. The frame 1 has a double bar support 12 in an open position. A channel 5 is located in the horizontal arm 17 of the frame 1 to receive the lenses 3. The lens 3 has a surface with no protrusions 31 that is received by the channel 5 of the lens 1. Double sided tape or adhesive 16 is used to assist in securing the lens to the frame. Once the lenses 3 are placed in the frame 1, the levers 18 and 19 close over the lenses 3, creating a wall and layering the lenses 3 between the levers 18 and 19 and the frame 1.

Finally, a retaining mechanism (not shown) such as a screw or pin engages each lever 18 and 19 and frame 1 to mechanically lock the lenses 3 to the frame 1. The outer edge of each lever 18 and 19 comprises an opening 22 for receiving the retaining mechanism. The inner screw or pin 23 is tightly attached to the frame 1, enough such that it cannot slip out of the frame 1, but the inner pin 23 is attached loosely enough to allow the levers 18 and 19 to pivot. This pivoting motion of the levers opens like a drawbridge, each lever pivoting upwardly, away from the lens 3. This allows enough space for the frame to receive the lens 3.

FIG. 14B shows another embodiment of the present invention. FIG. 14B shows a frame 1, a nosepiece 4, two lenses 3, a single bar support 14, and a bar clip 15. A single bar support 14 is a lengthwise bar comprising curved sections that follow the substantially arched sections of the frame. The single bar support 14 comprises first and second protrusions 24 and 25 attached to the inner wall of the bar, each protrusion adjacent to the nosepiece 4 and endpiece. The single bar is shaped to replicate the curvature of the lens, creating the channel that secures the frame and lenses together. Additionally, the single bar support comprises of protrusions at the bar ends, and a recess in the nasal area, that allows the bar to slide down and nest into the frame endpieces and a slot in the center of the bar 26 for receiving the bar clip 15.

The nosepiece 4, located in the middle of the frame 1, comprises a substantially rectangular shaped recess 27 for receiving a bar clip 15. The nosepiece 4 is further defined by an inlet on the upper surface of the nosepiece 4, perpendicular to the bar clip 15 for receiving the single bar support 14.

The lenses 3 have a surface without protrusions 31 that is received in the channel 5 of the horizontal arm 17. Double sided tape or adhesive 16 is used to aid in securing the lens 3 to the channel 5. The single bar support 14 is slidably received in the frame 1 and over the lenses 3 thereby securing the lenses to the frame. A bar clip 15, comprising first and second legs 28 and 29 on each end of the bar clip 15, engages the recess 27 in the nose piece 4. The legs 28 and 29 pass through the recess 27 and hook into the slot 26 of the single bar support 14. The legs 28 and 29 aid to securely lock the bar clip 15 into the single bar support 14.

FIG. 14C shows another embodiment of the present invention. A recess 5 in the horizontal arm 17 of the frame 1 receives a detached lens 3. The upper surface of the lens 3 has no protrusions, but does have two recesses 34 for receiving a screw or pin. Similar recesses are also present in the channel 5 of the horizontal arm 17 of the frame 1.

FIG. 14D shows the embodiment illustrated in FIG. 14C with the lens 3 and frame 1 assembled. Screws or pins 33 are used to secure the lens 3 to the frame 1. FIG. 14E shows a cross-section of the embodiment of the present invention illustrated in FIG. 14D. The screw or pin 33 extends through the lens 3 and into the frame 1 to secure the lens 3 to the frame 1.

When a particular embodiment has been chosen to illustrate the invention, it will be understood by those skilled in the art that various changes and modifications can be made therein without departing from the scope of the invention as defined in the appended claims.

What is claimed is:

1. An eyeglass frame assembly, comprising:
a frame having a horizontal arm;
a recess in said horizontal arm;
adhesive on at least one surface of said recess in said horizontal arm;
at least one lens having a first protrusion and a second protrusion; and
adhesive on at least one surface of said at least one lens;
wherein said recess in said horizontal arm is shaped to receive said first protrusion and said second protrusion of said at least one lens and said adhesive secures said at least one lens to an eyeglass frame.

2. An eyeglass frame assembly, comprising:
a frame having a temple piece, a nose piece, and a horizontal arm;
a recess in said horizontal arm;
at least one lens;
a locking member releasably connected to said horizontal arm by a first fastening means and pivotally connected to said horizontal arm by a second fastening means;
wherein said recess in said horizontal arm receives said at least one lens and said locking member secures said at least one lens to said frame.

3. The eyeglass frame assembly of claim 2, wherein
said at least one lens further comprises a first protrusion and a second protrusion; and
said recess in said horizontal arm receives said first protrusion and said second protrusion of said at least one lens.

4. The eyeglass frame assembly of claim 2, further comprising:
adhesive on at least one surface of said at least one lens; and
adhesive on at least one surface of said recess in said horizontal arm of said frame.

5. The eyeglass frame assembly of claim 3, further comprising:
a second locking member releasably connected to said frame by a first fastening means and pivotally connected to said frame by a second fastening means.

6. An eyeglass frame assembly, comprising:
a frame having a temple piece, a nose piece, and a horizontal arm;
a recess in said horizontal arm;
a locking member slidably connected to said recess in said horizontal arm; and
a fastening means for releasably securing said locking member in a fixed position;
wherein said locking member secures at least one lens to said frame.

7. The eyeglass frame assembly of claim 6, wherein
said locking member comprises two substantially parallel rails;
said recess in said horizontal arm comprises at least one slot that slidably receives said substantially parallel rails; and
said locking member further comprises a recess for receipt of said at least one lens.

8. The eyeglass frame assembly of claim 6, wherein
said fastening means is a pin.

9. The eyeglass frame assembly of claim 6, wherein
said at least one lens further comprises at least one protrusion;
said recess in said horizontal arm receives said at least one protrusion of said at least one lens;
said locking member is slidable over said at least one protrusion of said at least one lens;
said locking member secures said at least one protrusion of said at least one lens to said frame.

10. An eyeglass frame assembly, comprising:
a frame having a temple piece, a nose piece, and a horizontal arm;
at least one lens;
a recess in said horizontal arm;
a locking member releasably securing said at least one lens to said recess in said horizontal arm;
a fastening means for releasably securing said locking member to said horizontal arm of said eyewear frame;
a recess in said frame for receipt of said fastening means;
a recess in said locking member for receipt of said fastening means;
wherein said locking member is releasably attached to said frame by inserting said fastening means through said recess in said frame and through said recess in said locking member; and
said locking member secures said at least one lens to said frame.

11. The eyeglass frame assembly of claim 10, wherein
said at least one lens has a first protrusion and a second protrusion; and
said recess in said horizontal arm receives said first protrusion of said at least one lens and said second protrusion of said at least one lens.

12. The eyeglass frame assembly of claim 10, further comprising:
an adhesive on at least one surface of said recess in said horizontal arm.

13. An eyeglass frame assembly, comprising:
a frame having a temple piece, a nose piece, and a horizontal arm;
a recess in said horizontal arm;
at least one hole in said recess in said horizontal arm;
at least one lens; and
at least one hole in said at least one lens;
wherein a fastening means is inserted in said at least one hole in said at least one lens and in said at least one hole in said recess in said horizontal arm for securing said at least one lens to said frame.

14. A method of securing at least one lens to an eyeglass frame, comprising:
inserting at least one lens in a recess in a horizontal arm of a frame;
pivoting a locking member over said at least one lens;
fastening said locking member to said frame by a means for releasably fastening said locking member to said frame; and
securing said at least one lens to said frame.

15. The method of securing at least one lens to an eyeglass frame of claim 14, further comprising:
further securing said at least one lens to said frame using an adhesive.

16. The method of securing at least one lens to an eyeglass frame of claim 14, further comprising:
inserting a first protrusion of said at least one lens into said recess of said horizontal arm of said frame;
inserting a second protrusion of said at least one lens into said recess of said horizontal arm of said frame.

17. A method of securing at least one lens to an eyeglass frame, comprising:
inserting a first protrusion of at least one lens into a recess in a horizontal arm of a frame;
inserting a second protrusion of said at least one lens into said recess in said horizontal arm of said frame;
sliding a locking member connected to said recess in said horizontal arm of said frame over said second protrusion of said at least one lens;
fastening said locking member in a fixed position to said frame by a means for fastening; and
securing said at least one lens to said frame by fastening said locking member to said fame.

18. A method of securing at least one lens to an eyeglass frame, comprising:
inserting at least one lens in a first recess in a horizontal arm of a frame;
locking a locking member over said at least one lens;
locking said locking member over said horizontal arm of said frame;
inserting a fastening means through a second recess in said horizontal arm of said frame;
inserting said fastening means through a recess in said locking member;
fastening said locking member to said frame by said means for fastening; and
securing said at least one lens to said frame.

19. The method of claim 18, further comprising:
inserting a first protrusion on said at least one lens into said first recess in said horizontal arm of said frame;
inserting a second protrusion on said at least one lens into said first recess in said horizontal arm of said frame.

20. The method of claim 18, further comprising:
releasably adhering said at least one lens to said recess in said horizontal arm of said eyeglass frame with adhesive means.

21. A method of securing at least one lens to an eyeglass frame, comprising:
applying adhesive to at least one surface of at least one lens;
applying adhesive to at least one surface of a recess in a horizontal arm of an eyeglass frame;
inserting a first protrusion of said at least one lens into said recess of said horizontal. arm;
inserting a second protrusion of said at least one lens into said recess of said horizontal arm;
wherein said first protrusion and said second protrusion and said adhesive applied to said at least one lens and said adhesive applied to said recess of said horizontal arm act to secure said at least one lens to said frame.
